(19) United States
(12) Patent Application Publication
(10) Pub. No.: US 2014/0151995 A1
(43) Pub. Date: Jun. 5, 2014

(54) Coupon Organizer

(71) Applicant: Kerry Webber - Scalzo, Norwood, MA (US)

(72) Inventor: Kerry Webber - Scalzo, Norwood, MA (US)

(21) Appl. No.: 13/693,179

(22) Filed: Dec. 4, 2012

(51) Int. Cl. B42D 3/00; B42D 15/00

(52) U.S. Cl. CPC B42D 3/00; B42D 15/00
USPC 283/52; 281/31

(57) ABSTRACT

A coupon organizer formed as an accordion style folder having transparent pockets, transparent folder partitions, and appropriately entitled partition tabs. The size of the instant coupon organizer can vary but is usually sized to fit conveniently inside a shopper's purse for easy access and availability.

### PRIORITY

This application claims priority based on provisional patent application 61/567,976 filed on Dec. 7, 2011.

### FIELD OF THE INVENTION

The present invention relates generally to a coupon organizer adapted to fit within a purse of a shopper and use while shopping to thereby save time and money.

### BACKGROUND OF THE INVENTION

Using coupons while shopping can be quite a physical challenge when a shopper has a large number of coupons to carry and filter through while perusing through isles of different items. A relatively large amount of time is spent on each item being viewed when a shopper has to sift through a large number of coupons to locate an applicable coupon for each individual item.

Currently, when a shopper goes to a store to shop with coupons they usually simply throw their coupons into a purse or carry-all and then fumble through the pile each time when trying to locate an applicable coupon. This takes a lot of time and causes frustration over and over again as a shopper considers each item. Sometimes shoppers use a simple bill fold or other type of simple folder to keep the coupons together, however, the same problems exist when trying to locate particular coupons for particular items.

Therefore, there exists a need for a device for holding and organizing coupons such that a shopper can locate an appropriate coupon in short order each time an item is being considered.

### SUMMARY OF THE INVENTION

In view of the foregoing disadvantages inherent in the known devices and methods set forth in the prior art, the present invention, which will be described subsequently in greater detail, is to provide a device and method for storing, organizing, and using coupons that will reduce the time and frustration shoppers currently experience every time they shop and use coupons.

The instant invention consists of a specially configured and sized coupon organizer formed as an accordion style folder having transparent pockets, transparent folder partitions, a plurality of transparent pockets upon each side of each partition, and appropriately entitled partition tabs. The size of the instant coupon organizer can vary but is usually sized to fit conveniently inside a shopper's purse for easy access and availability.

The method of using the instant invention includes the steps of placing a shopping and/or to-do lists in any of the provided transparent pockets, appropriately filing each coupon within a pocket of an appropriate partition following the partition tab titles, carrying the coupon organizer while shopping, removing and following the shopping and/or to-do lists, using the partition tabs to locate appropriate coupons for each item, viewing the available coupons for each item through the transparent partitions, then deciding which item to purchase based on the available coupons. Finally, when paying for the items, using the tabs and partitions to locate and retrieve the appropriate coupons for presentation and use.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 shows a perspective view of the coupon organizer.

FIG. 2 shows a front view of the coupon organizer showing the transparent plastic pocket.

FIG. 3 shows the front cover opened with a pocket on the inside thereof.

FIG. 4 shows one of the inside sheets with the pockets for coupons and a tab.

### DETAILED DESCRIPTION OF THE PREFERRED EMBODIMENT

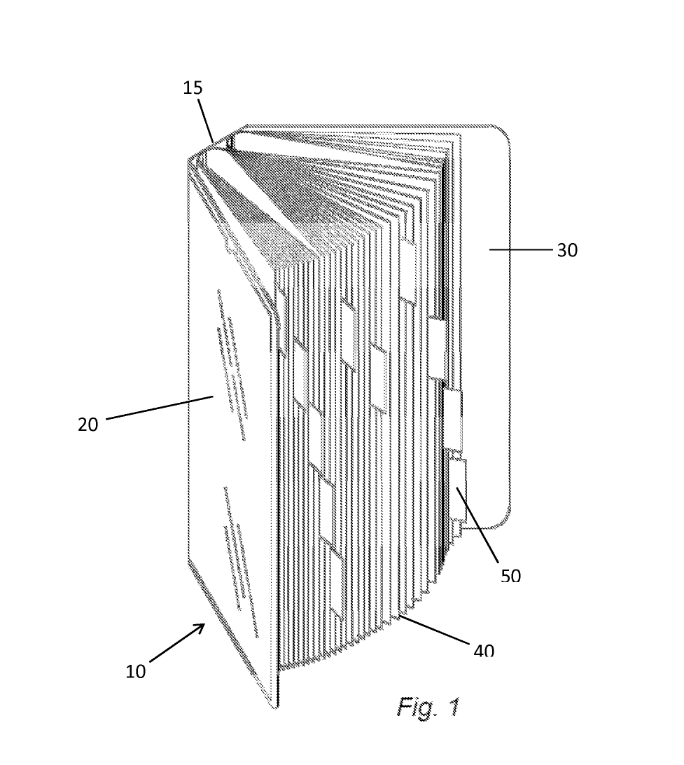

As per FIG. 1, the coupon organizer (10) is formed as an accordion style folder having a front cover (20), a back cover (30), a spine portion (15), a plurality of transparent partitions (40), and a plurality of partition tabs (50) respectively placed on the side edge portion of each chosen partition to thereby separate the partitions into appropriate groups. Each partition tab is appropriately marked in with identification markers to clearly discern sections of partitions to thereby create groupings of coupons that can be easily accessed when desired.

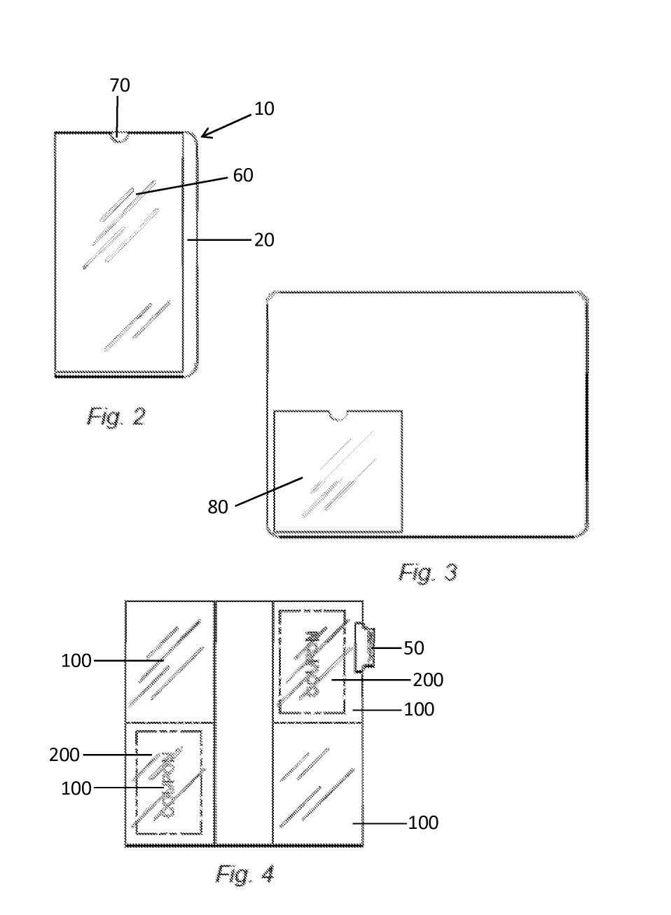

FIG. 2 shows the front cover (20) of the organizer including a transparent plastic cover (60) forming a front pocket (70), which can be used to hold a shopping or to-do list.

FIG. 3 shows the front cover of the organizer in an opened position and including a transparent plastic pocket (80), which can also be used to hold a shopping or to-do list.

FIG. 4 shows one of the transparent partition sheets (40) including a plurality of pockets (100) for coupons (200) to be inserted and removed therefrom, and a partition tab (50) having writing thereon discerning the title for that particular section of partitions and coupons.

The optimal dimensions of the coupon organizer is such that it is formed having a height of between 6 inches and 10 inches, and a width of between 3 inches and 6 inches, to thereby fit easily in most purses or carry-all bags used by many shoppers. The optimum size being 7 inches in height and 4 inches in width.

The method of using the instant invention includes the steps of placing a shopping and/or to-do lists in any of the provided transparent pockets, appropriately filing each coupon (200) within a pocket (100) of an appropriate partition (40) following the partition tab titles, carrying the coupon organizer while shopping, removing and following the shopping and/or to-do lists, using the partition tabs (50) to locate appropriate coupons for each item, viewing the available coupons for each item through the transparent partitions, then deciding which item to purchase based on the available coupons. Finally, when paying for the items, using the tabs and partitions to locate and retrieve the appropriate coupons for presentation and use.

The instant invention consists of a specially configured and sized coupon organizer formed as an accordion style folder having transparent pockets, transparent folder partitions, a plurality of transparent pockets upon each side of each partition, and appropriately entitled partition tabs. The size of the instant coupon organizer can vary but is usually sized to fit conveniently inside a shopper's purse for easy access and availability.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed:

1. A coupon organizer for storing and organizing coupons, said coupon organizer formed as a folder comprising a front cover and a back cover, wherein one edge of said back cover is hingedly connected to one edge of said front cover; a plurality of partitions placed between said front and back covers, wherein each said partition has a first edge hingedly connected to the connected edges of said front and back covers; a plurality of partition tabs respectively attached to a second edge opposite of said first edge of respectively chosen partitions, thereby forming discernible groupings of partitions; wherein each said partition has a plurality of pockets formed thereon that are adapted to hold coupons therein; wherein said plurality of partitions and pockets are made of a transparent material such that said coupons can be easily viewed when inside said pockets; said front cover further including a pocket on a front side for storing a shopping list, and a pocket on an inner side for storing a second shopping list.

2. The coupon organizer of claim 1, wherein said folder is formed as an accordion-style folder, such that said connection between said front and back covers forms a spine portion; and wherein said plurality of partitions are connected on said first edges to said spine portion; and wherein each of said plurality of partitions are respectively connected at top and bottom edges to their respective adjacent partitions to thereby form an accordion-style folder.

3. The coupon organizer of claim 1, wherein each said partition has a plurality of pockets on front and back sides thereof.

4. The coupon organizer of claim 3, wherein each said partition has four pockets on both front and back sides thereof.

5. The coupon organizer of claim 1, wherein said partition tabs have identification markers on them to aid in discerning particular groupings of said partitions.

6. The coupon organizer of claim 1, wherein said front cover pocket and said inner side pocket are formed from a transparent material.

7. The coupon organizer of claim 1, wherein said partitions, said partition pockets, said front cover pocket, and said inner side pocket are formed from a transparent plastic.

8. The coupon organizer of claim 1, wherein said coupon organizer is formed having height of between 6 inches and 10 inches, and a width of between 3 inches and 6 inches.

9. The coupon organizer of claim 8, wherein said coupon organizer is formed as having height of 7 inches, and a width of 4 inches.

10. A combination of a coupon organizer and a plurality of coupons, said organizer formed as a folder comprising a front cover and a back cover, wherein one edge of said back cover is hingedly connected to one edge of said front cover; a plurality of partitions placed between said front and back covers, wherein each said partition has a first edge hingedly connected to the connected edges of said front and back covers; a plurality of partition tabs respectively attached to a second edge opposite of said first edge of respectively chosen partitions, thereby forming discernible groupings of partitions; wherein each said partition has a plurality of pockets formed thereon that are adapted to hold said coupons therein; wherein said plurality of partitions and pockets are made of a transparent material such that said coupons can be easily viewed when inside said pockets; said front cover further including a pocket on a front side for storing a shopping list, and a pocket on an inner side for storing a second shopping list.

11. The combination of claim 10, wherein said folder is formed as an accordion-style folder, such that said connection between said front and back covers forms a spine portion; and wherein said plurality of partitions are connected on said first edges to said spine portion; and wherein each of said plurality of partitions are respectively connected at top and bottom edges to their respective adjacent partitions to thereby form an accordion-style folder.

12. The combination of claim 10, wherein each said partition has a plurality of pockets on front and back sides thereof.

13. The combination of claim 12, wherein each said partition has four pockets on both front and back sides thereof.

14. The combination of claim 10, wherein said partition tabs have identification markers on them to aid in discerning particular groupings of said partitions.

15. The combination of claim 10, wherein said front cover pocket and said inner side pocket are formed from a transparent material.

16. The combination of claim 10, wherein said partitions, said partition pockets, said front cover pocket, and said inner side pocket are formed from a transparent plastic.

17. The combination of claim 10, wherein said coupon organizer is formed having height of between 6 inches and 10 inches, and a width of between 3 inches and 6 inches, such that said coupon organizer is adapted to fit within a purse of a shopper.

18. The combination of claim 17, wherein said coupon organizer is formed as having height of 7 inches, and a width of 4 inches.
